(19) United States
(12) Patent Application Publication
(10) Pub. No.: US 2018/0178574 A1
(43) Pub. Date: Jun. 28, 2018

(54) Composite Doctor Blade Chamber

(71) Applicant: Tresu A/S, Sdr. Stenderup (DK)

(72) Inventor: Jan Kjær Larsen, Sdr. Stenderup (DK)

(21) Appl. No.: 15/579,237

(22) PCT Filed: Jun. 2, 2016
(86) PCT No.: PCT/DK2016/050160

§ 371 Date: Dec. 4, 2017

(30) Foreign Application Priority Data
Jun. 4, 2015 (DK) PA 2015 70346

(51) Int. Cl. B41N 7/06; B29D 22/00; B41F 31/04; C09J 5/00

(52) U.S. Cl. CPC B41N 7/06; B29D 22/00; B29K 2063/00; C09J 5/00; B41F 31/04

(57) ABSTRACT

A composite doctor blade chamber (1) for a doctor blade chamber system for rotary printing units, the doctor blade chamber (1) including a front side with an open channel (8), wherein the doctor blade chamber is made of two composite profiles, an open profile (30) with a front side and a back side and a closed profile (33) with a front side and a back side, wherein the front side (31) of the open profile is joined with the back side of the closed profile (35), whereby is achieved low weight and high strength, high corrosion resistance, a cleaning-friendly surface, less waste of ink, nice appearance and an improved working environment. In addition it is an object of the invention to provide a doctor blade chamber system with the above mentioned advantages where re placement of doctor blades can be performed faster, more easily and without use of tools.

### FIELD OF THE INVENTION

The present invention concerns a method for making a composite doctor blade chamber that includes two composite profiles.

The invention further concerns a composite doctor blade chamber for a doctor blade chamber system for rotary printing units, the doctor blade chamber including a front side with an open channel.

In addition, the present invention concerns a doctor blade chamber system for rotary printing units including a doctor blade chamber, a clamping rail and a doctor blade.

Furthermore, the invention concerns use of a doctor blade chamber system.

### BACKGROUND OF THE INVENTION

In rotating printing units for offset printing, flexo printing and other kinds of printing, there are advantageously used systems comprising so-called doctor blade chambers. A doctor blade chamber is an ink container which by means of so-called doctor blades fits tightly to an ink transfer roller, and from which container ink is transferred to this roller, which transfers the ink to further rollers forming a part of the printing process.

The doctor blade chamber, which may be several meters long, consists mainly of a front side, which side is the one facing the roller, the front side including an open channel and two or more doctor blades secured on the doctor blade chamber. These doctor blades are thin, elongated blades having one longitudinal side securely connected to the doctor blade chamber and with their opposite sides bearing against the roller under a certain spring force.

The doctor blade chamber is usually made of metal, preferably aluminium, due to the mechanical properties desired in connection with lengths of one meter or more, where it e.g. is possible to extrude aluminium. Stainless steel is also an option, but the material is much more expensive and heavier than e.g. aluminium.

The choice of material for a doctor blade chamber also depends on the inks, primers and lacquer wanted to be used. Today, e.g. inks that are basic are used, thus causing a problem with corrosion of doctor blade chambers of aluminium. In order to relieve this, coating the doctor blade chambers, or at least their front side that is in contact with aggressive inks, with polytetrafluoroethylene (PTFE) has been attempted.

However, this has appeared to be disadvantageous as polytetrafluoroethylene (PTFE) is only partially pH-resistant and therefore can be dissolved by certain inks, lacquers and primers. Alternatively, metal may be coated by nickel-plating or chromium-plating. This is, however, difficult if not impossible to do, especially when the doctor blade chamber is of aluminium.

The doctor blade chamber and the surface coating are at the same time to be resistant to cleaning liquids where e.g. ethanol also can dissolve polytetrafluoroethylene (PTFE).

Often two doctor blades are used in a doctor blade chamber system, where one doctor blade provides sealing for the ink chamber against the roller, and the other provides for sealing the ink chamber against the roller as well as supplying the roller with an even layer of ink; these functions are advantageous compared with systems where the roller collects ink from an open ink container as it is difficult to achieve an even and precise ink transfer.

The doctor blades which, in spite of this common name, also can be made of synthetic material, are wear parts in a printing unit. A doctor blade is a thin blade resting on the ink transfer roller, for example the raster roller.

Depending on the quality of the roller and on the ink, a doctor blade lasts between one day and several weeks after which it has to be replaced. For replacing the doctor blade, according to prior art the doctor blade chamber usually has to be taken out of the printing unit, which is a disadvantage. After dismounting a clamping rail provided on the doctor blade chamber and keeping the doctor blade clamped between the clamping rail and the doctor blade chamber, the doctor blade can be replaced, after which the clamping rail is mounted again.

According to prior art, this clamping rail is screwed onto the doctor blade chamber by a number of screws, implying some disadvantages. First, quite a number of screws (10 screws per meter of doctor blade chamber) have to be loosened and tightened, making the replacing process slow. Second, it is a well-known problem that the clamping rail does not clamp quite evenly on the doctor blade as the screw system implies a raised pressure right around the screws. The consequence is that the doctor blade does not lie evenly to the roller but “flickers”, i.e. having a shape like a wave. These variations in spacing between the doctor blade and the roller, even though they are very small—in the magnitude of few micron—, result in the application of ink on the roller not being quite even, thereby depreciating the printing quality. Furthermore, at the areas between the screws ink may penetrate between the doctor blade and the clamping rail and between the doctor blade and the doctor blade chamber, further enhancing the “flickering” effect and requiring frequent cleaning. Third, tools are required for loosening and tightening the screws. During work it may be a great source of irritation for the workers if this tool is not available for the replacement, for example because a colleague has mislaid it.

Alternatively, the clamping rail according to the prior art can be designed with a groove fitting to a profiled rail and where the profiled rail also fits a groove in the doctor blade chamber such that the clamping rail thereby is secured to the doctor blade chamber.

As it is commonly known the doctor blade chamber is closed at both ends with sealings or packings as the ink chamber otherwise would be open and the ink run out of the ends instead of being supplied to the roller.

### OBJECT OF THE INVENTION

It is the object of the present invention i.a. to indicate a solution to the indicated problems and which also enables the making of doctor blade chambers that
have low weight and high strength;
have high corrosion resistance with regard to inks and cleaning liquids with high pH values without the risk of degrading the doctor blade chamber, neither due to chemical impact of the applied inks/lacquers/primers nor due to destruction of the surface coating by cleaning liquids;
enable locally performed repairs;
have a cleaning-friendly surface which is an advantage when running short productions/series with frequent job changes (100 job changes a day is not unnormal), where the inks are to be exchanged and the chambers therefore also to be cleaned, in particular carefully cleaned in case of completely covering ink, and where the inks more easily run out of the chamber due to the smooth surface;
due to a smaller volume cause less waste of ink by job changes, with less impact on the environment;
are designed industrially with a nice appearance;
entail an improved working environment by a weight reduction of about 40% compared with current doctor blade chambers.

It is a further object of the invention to provide a doctor blade chamber system with the above mentioned advantages where the clamping arrangement for doctor blades is designed such that replacement of doctor blades can be performed faster, more easily and without use of tools.

### DESCRIPTION OF THE INVENTION

According to a first aspect of the invention, the above mentioned object is achieved by a method for making a composite doctor blade chamber including two composite profiles as described in the introduction and as described in the preamble of claim 1, wherein the method includes at least the following steps, wherein an open profile with a front side and a back side and a closed profile with a front side and a back side are joined by front side of the open profile and the back side of the closed profile.

This enables achieving a weight reduction compared with aluminium. When previously a person handled doctor blade chambers of 2 metres, typically weighing up to 15 kg, the load will now be substantially lower when the doctor blade chamber is made of composites instead of aluminium. However, there may be situations where two persons are required to handle e.g. 5.5 metres long doctor blade chambers for use in printing cardboard, though this is more due to the fact that items of such length are more unwieldy than items of shorter length. By a weight reduction of about 40% compared with current doctor blade chambers, the composite doctor blade chamber thus provides a better working environment as well.

In a second aspect, the present invention also concerns a method for making a composite doctor blade chamber, wherein the front side of the open profile and the back side of the closed profile are joined by glue.

This will enable joining the two profiles without using screws or corresponding joining means or joining means that require high temperatures.

In a third aspect, the present invention also concerns a method for making a composite doctor blade chamber, wherein at least part of the composite doctor blade chamber is made by means of one of the following processes: pultruding; moulding.

This enables making the entire composite doctor blade chamber by means of one of the processes pultruding and moulding, but it will also be possible e.g. to make the open composite profile by means of pultrusion and the closed composite profile by means of moulding, or alternatively to make the closed composite profile by means of pultrusion and the open composite profile by means of moulding.

In a fourth aspect, the present invention also concerns a composite doctor blade chamber according to the method indicated in claims 1 to 3 for a doctor blade chamber system for rotary printing units, wherein the doctor blade chamber includes a front side with an open channel, wherein the doctor blade chamber further includes two composite profiles, an open profile with a front side and a back side and a closed profile with a front side and a back side, wherein the front side of the open profile is joined with the back side of the closed profile.

This enables achieving a weight reduction compared with aluminium. When previously a person handled doctor blade chambers of 2 metres, typically weighing up to 15 kg, the load will now be substantially lower when the doctor blade chamber is made of composites instead of aluminium. However, there may be situations where two persons are required to handle e.g. 5.5 metres long doctor blade chambers for use in printing cardboard, though this is more due to the fact that items of such length are more unwieldy than items of shorter length. By a weight reduction of about 40% compared with current doctor blade chambers, the composite doctor blade chamber thus provides a better working environment as well.

This will also make it easier, faster and cheaper to make two separate composite profiles and then join them instead of making the composite doctor blade chamber in a composite profile as the complexity of a single profile will be considerably greater and will be more difficult to achieve comparable results with.

In a preferred embodiment, the doctor blade chamber can be made by means of pultrusion where fibre bundles are drawn through fluid polyester and through a heated steel nozzle where hardening takes place. The desired profile of the composite doctor blade chamber is achieved in a preferred embodiment by drawing the fibres through a nozzle with a shape corresponding to the desired composite doctor blade chamber.

Pultruding can also be performed in another way where resin is injected into a tool where the profile subsequently is hardened.

An alternative production method for making doctor blade chambers is moulding/manual laying, wherein alternately a layer of fibres is laid, after which the layer is soaked with fluid binder/resin.

The resin used for the composite doctor blade chamber may e.g. be epoxy, polyester or vinyl ester. This enables an industrially designed composite doctor blade chamber with a nice appearance, for example a so-called “carbon look”.

In a preferred embodiment there is a smaller volume in the ink chamber than in traditional doctor blade chambers, which is an advantage when running short productions/series with frequent job changes, where the inks are to be exchanged and the chambers therefore also to be cleaned, entailing less waste of ink at each job change, thereby providing a reduced impact on the environment.

In a preferred embodiment, the closed profile may additionally include foam in the cavity, the foam having the capacity of contributing to maintaining the shape of a profile as well as being noise- and shock-absorbing.

In a fifth aspect, the present invention also concerns a composite doctor blade chamber, wherein the composite profiles at least include carbon fibres.

This will also enable achieving a doctor blade chamber that is lighter as well as stronger than by conventional materials. Besides, there is a good corrosion resistance. Where aluminium may corrode due to the strong basic inks and cleaning liquids with pH up to 11, this is not the case with the composites in question as it is the resin which is exposed to the base and not e.g. the carbon fibres as the carbon fibres, which are essential for the weight and the strength of the doctor blade chamber profile, do not constitute the surface coating.

Inks and cleaning liquids with high pH values can therefore be applied without risk in connection with the composite doctor blade chamber and without risking the degradation thereof, neither due to chemical impact of the applied inks/lacquers/primers nor due to chemical action by cleaning liquids.

In a preferred embodiment, the surface is also cleaning-friendly due to a smooth surface, which is an advantage when running short productions/series with frequent job changes, where the inks are to be exchanged and the chambers therefore also to be cleaned, as the inks will run out of the chamber more easily due to the smooth surface.

This will therefore enable performing local surface repairs on the doctor blade chamber as these can be performed with resin.

In a preferred embodiment, each single composite doctor blade chamber comprises two layers, each with a thickness of 2 mm, and each layer comprising 6 fibre mats.

In a further preferred embodiment, the composite is constituted by 80% carbon fibre and 20% glass fibre, and in addition resin.

In yet a further preferred embodiment, the composite is constituted by 60% carbon fibre and 40% resin.

In a sixth aspect, the present invention also concerns a composite doctor blade chamber wherein the joining of the profiles includes glue.

This will enable joining of the two profiles without using screws or similar joining means, or joining means that require high temperatures.

Examples of glue types are epoxy glue, acrylic glue and polyurethane glue.

In a seventh aspect, the present invention also concerns a composite doctor blade chamber, wherein the composite doctor blade chamber includes a groove, preferably a T-shaped groove, at either side of and along the open channel.

This will enable mounting of a profiled rail such that it engages both a groove in the composite doctor blade chamber and a groove in a clamping rail, between which a doctor blade is secured.

In a preferred embodiment, the profiled rail has a length substantially corresponding to the composite doctor blade chamber. In addition, a part of the profiled rail extending in the groove of the composite doctor blade chamber has a width substantially corresponding to the width of the groove.

In an eighth aspect, the present invention also concerns composite doctor blade chamber wherein the composite doctor blade chamber at least includes a cleaning nozzle in the open channel.

This will enable flushing and cleaning of the open channel of the composite doctor blade chamber from several sides.

In a preferred embodiment there is fitted at least one cleaning nozzle at either end of the open channel in the proximity of the packing area, where the nozzles are capable of flushing out towards edges and corners at pressure of 3.5 bar.

In a further preferred embodiment, a hole is drilled through the composite doctor blade chamber and the cleaning nozzle is glued therein such that the cleaning liquid is supplied from the back side of the composite doctor blade chamber.

In a ninth aspect, the present invention also concerns a composite doctor blade chamber as described by introduction, namely a doctor blade chamber system for rotary printing units including a doctor blade chamber, a clamping rail and a doctor blade, wherein the doctor blade chamber is a composite doctor blade chamber, and where the doctor blade is clamped between the clamping rail and the composite doctor blade chamber, the clamping action being provided by an elongated profiled rail with a first side engaging a groove in the clamping rail, preferably a T-shaped groove, and with a second side engaging a groove in the composite doctor blade chamber, preferably a T-shaped groove, wherein a resilient element displaces the profiled rail in the groove of the doctor blade chamber inwards in direction of the bottom of the doctor blade chamber groove, the resilient element including elastic foam provided between a wall of the doctor blade chamber groove, the wall being opposite the bottom of the doctor blade chamber groove, and the profiled rail, such that the foam by expansion urges the profiled rail in direction towards the bottom of the doctor blade chamber.

This enables maintaining a tension on the clamping rail of 12 kg for each 100 mm in longitudinal direction, without using any tools. Besides, the foam acts a sealing between the profiled rail and the open end of the groove of the composite doctor blade chamber. The pores in the foam can be compressed such that the foam takes up less space, but if the foam is not applied a force, the pores will expand whereby the foam will apply a tensile force on the profiled rail.

In a tenth aspect, the present invention also concerns a doctor blade chamber system, wherein the doctor blade chamber system also includes a rigid oval tube that is rotatable about its longitudinal axis, the tube disposed between the bottom of the groove and the profiled rail in the groove, the rigid oval tube that is rotatable about its longitudinal axis counteracting the resilient foam when activated so that the doctor blade thereby is no longer clamped between the clamping rail and the composite doctor blade chamber.

This will enable avoiding of an overpressure chamber in the composite doctor blade chamber groove whereby the risk of crack formation between the two composite profiles of the composite doctor blade chamber is eliminated as well.

The rigid oval tube that is rotatable about its longitudinal axis thus constitutes a displacing mechanism which in a preferred embodiment can be manually activated by means of a handle or via a lever actuated by electric, pneumatic or hydraulic means.

In a preferred embodiment, the rigid oval tube that is rotatable about its longitudinal axis is capable of lifting the clamping rail and thereby releasing or loosening the doctor blade and increasing the spacing between the composite doctor blade chamber and the clamping rail.

In an eleventh aspect, the present invention also concerns a doctor blade chamber system, wherein the doctor blade chamber system also includes an elastic tube disposed in the groove of the composite doctor blade chamber between the bottom of the groove and the profiled rail in the groove, the elastic tube capable of pneumatically expanding and counteracting the resilient foam when activated so that the doctor blade thereby is no longer clamped between the clamping rail and the composite doctor blade chamber.

This will also enable avoiding an overpressure chamber in the composite doctor blade chamber groove whereby the risk of crack formation between the two composite profiles of the composite doctor blade chamber is eliminated as well.

The elastic tube thus also constitutes a displacing mechanism.

In a preferred embodiment, the rigid oval tube is a hose which, when inflated, is capable of lifting the clamping rail, thereby releasing or loosening the doctor blade and increasing the spacing between the composite doctor blade chamber. Moreover, a hose operates along its entire length and can therefore also operate in the length of the composite doctor blade chamber.

In a twelfth aspect, the present invention also concerns a doctor blade chamber system, wherein the doctor blade chamber system includes an air supply.

This will enable supplying the required air to the elastic tube/hose by means of e.g. a small manual, mechanical or electric pump. Alternatively, compressed air can be used if, as often is the case, it is available close to the printing unit. By itself or via valves, the air supply is to maintain a constant pressure in the elastic tube/hose in the period of time it takes to replace the doctor blade where the pressure is to counteract the force from the resilient foam.

In a thirteenth aspect, the present invention also concerns a doctor blade chamber system according to claims 9 to 12 for use in a printing unit, e.g. a flexographic printing unit.

### DESCRIPTION OF THE DRAWING

The invention will now be explained more closely in the following by description of non-limiting embodiments with reference to the drawing, where:

FIG. 1 shows a part of a doctor blade chamber according to prior art in perspective view;

FIG. 2 shows a cross-section of a doctor blade chamber according to prior art;

FIGS. 3a-b shows a cross-section through a part of a doctor blade chamber according to prior art where an elastic tube is used in the displacing mechanism;

FIGS. 3c-d shows a cross-section through a part of a doctor blade chamber according to prior art where a rigid oval tube that is rotatable about its longitudinal axis rail is used in the displacing mechanism;

FIG. 4 shows a cross-section through part of a doctor blade chamber according to prior art where the profiled rail is shaped so that the clamping rail may be lifted off the doctor blade chamber in an easy way;

FIG. 5 shows a composite doctor blade chamber according to the invention in a cross-sectional view where the two profiles are separated;

FIG. 6 shows a composite doctor blade chamber according to the invention in a cross-sectional view where the two profiles are joined;

FIG. 7 shows a composite doctor blade chamber according to the invention in a perspective view;

FIG. 8 shows a composite doctor blade chamber according to the invention in a cross-sectional view through a nozzle;

FIGS. 9a-d shows the same as FIGS. 3a-d where the wave spring is substituted by an elastic profile of foam polymer;

FIG. 10 shows the same as FIG. 4 where an elastic profile of foam polymer is also shown.

### LIST OF DESIGNATIONS

1 doctor blade chamber

2 end piece

4 doctor blade

5 clamping rail

6 bolt

7 ink chamber

8 open channel

9 ink transfer roller

10 surface of ink transfer roller

11 part of the ink transfer roller inside the ink chamber

14 groove in the doctor blade chamber

15 groove in the clamping rail

16 profiled rail

17 interspace between one side of profiled rail and inner edge of the doctor blade chamber

18 one side of profiled rail for disposing in doctor blade chamber groove

19 inner edge of doctor blade chamber groove

20 wave spring

21 bottom of doctor blade chamber groove

22 interspace between profiled rail and bottom of doctor blade chamber groove

23 sidewall of doctor blade chamber groove

24 elastic tube in interspace between profiled rail and bottom of doctor blade chamber groove, displacing mechanism

25 internal volume of elastic hose

26 eccentric tube, displacing mechanism

27 resilient profile of foam polymer

29 edge

30 open profile

31 front side, open profile

32 back side, open profile

33 closed profile

34 front side, closed profile

35 back side, closed profile

36 foam

37 nozzle aperture

38 nozzle

39 threaded insert

### DETAILED DESCRIPTION OF EMBODIMENTS OF THE INVENTION

FIG. 1 is a schematic of a part of a doctor blade chamber 1 according to prior art in perspective view. For the sake of illustration, the doctor blade chamber 1 is shown without end casing normally sealing off the end part 2 so that the ink does not run out of the doctor blade chamber 1. A doctor blade 4 clamped between a clamping rail 5 and the doctor blade chamber 1 is mounted on the doctor blade chamber 1. Clamping rails 5 are screwed onto the doctor blade chamber 1 with bolts 6. Together with the doctor blades 4 the doctor blade chamber 1 constitutes the walls of the ink chamber 7. The open channel 8 between the doctor blades 4 is closed when the doctor blade chamber 1 is adjusted towards the ink transfer roller.

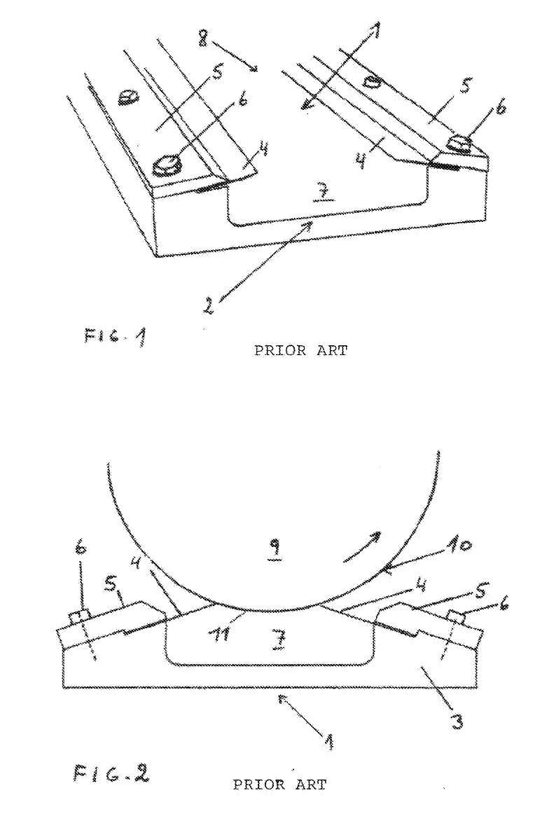

FIG. 2 shows a cross-section through the doctor blade chamber 1 according to prior art and an ink transfer roller 9. Together with the two doctor blades 4 touching the surface 10 of the roller, the ink chamber 7 is largely closed. When the ink transfer roller 9 rotates about its axis, the part of the roller 11 inside the ink chamber 7 collects ink which it gives off to other rollers in the printing unit. According to prior art, the clamping rails 5 are screwed onto the doctor blade chamber 1 with bolts.

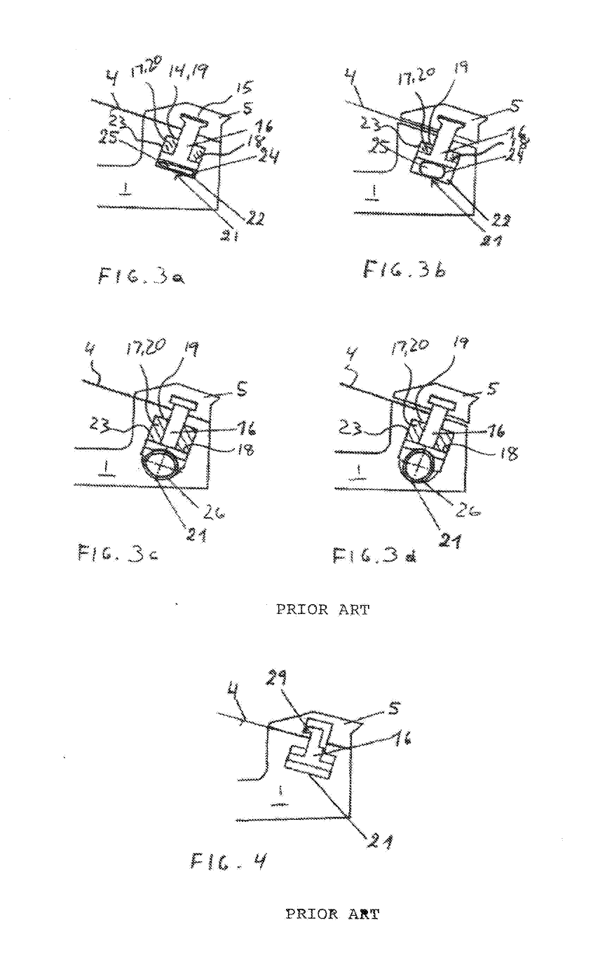

FIGS. 3a and 3b show a cross-section through one side of the doctor blade chamber according to prior art for fixing a doctor blade 4, where the doctor blade chamber 1 is formed with a T-shaped groove 14 with bottom 21 and sidewalls 23, and the clamping rail 5 is formed with a groove 15 which is largely T-shaped. The latter groove 15 could also be T-shaped. The profiled rail 1 is designed so as to fit in the two grooves 14 and 15 such that the doctor blade chamber 1 and the clamping rail 5 are connected by mounting the profiled rail 16.

In the interspaces 17 between one T-shaped side 18 of the profiled rail and the inner edge 19 of the groove 14 of the doctor blade chamber, the inner edge 19 being the edge opposite to the bottom 21 of the doctor blade chamber groove 14, there is provided a wave spring 20 (shown by hatching) urging the inner edge 19 of the doctor blade chamber groove 14 and one T-shaped side 18 of the profiled rail away from each other so that the profiled rail 16 is displaced inwardly towards the bottom 21 of the groove. Hereby, a force is exerted on the clamping rail 5 against the doctor blade chamber 1, whereby the doctor blade 4 is clamped therebetween. There is furthermore a displacing mechanism including an elastic tube 24 in the interspace 22 between the profiled rail 16 and the bottom 21 of the doctor blade chamber, wherein the internal volume 25 of the elastic tube can be filled with gas which under pressure expands the elastic tube 24 (see FIG. 3b), counteracting the spring force, whereby the profiled rail 16 is pressed away from the doctor blade chamber bottom 21. The doctor blade 4 is thereby no longer clamped between the clamping rail 5 and the doctor beam 1 and can be removed.

As an alternative to the resilient tube 24, in the displacing mechanism can be used a rigid oval tube 26 that is rotatable about its longitudinal axis, see FIGS. 3c and 3d, disposed between the bottom 21 of the doctor blade chamber groove and the profiled rail 16. By rotating the tube 26, the profiled rail 16 is pressed away from the bottom 21 of the doctor blade chamber groove, whereby the clamping rail 5 is released from its clamping action.

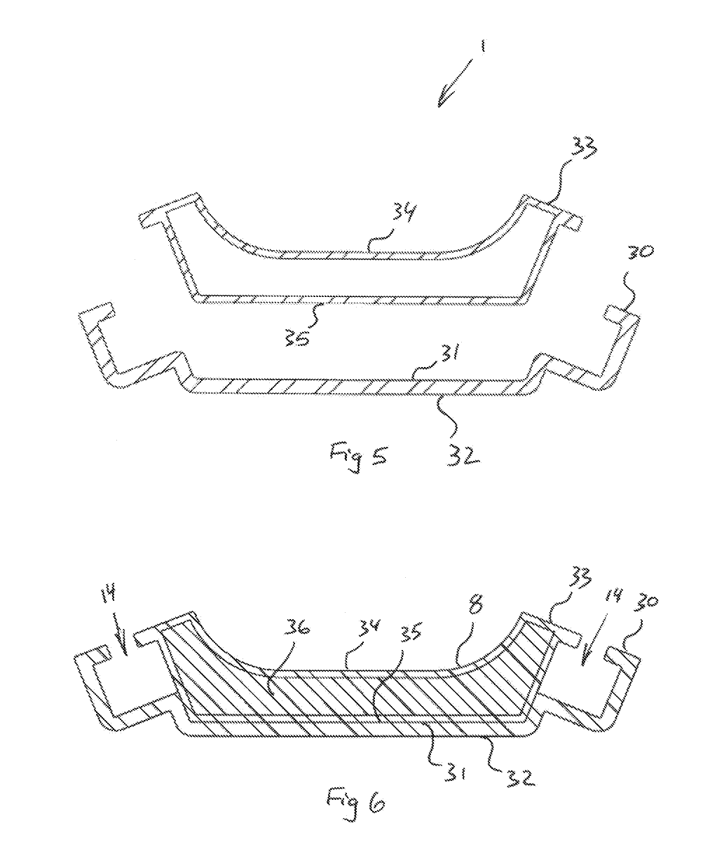

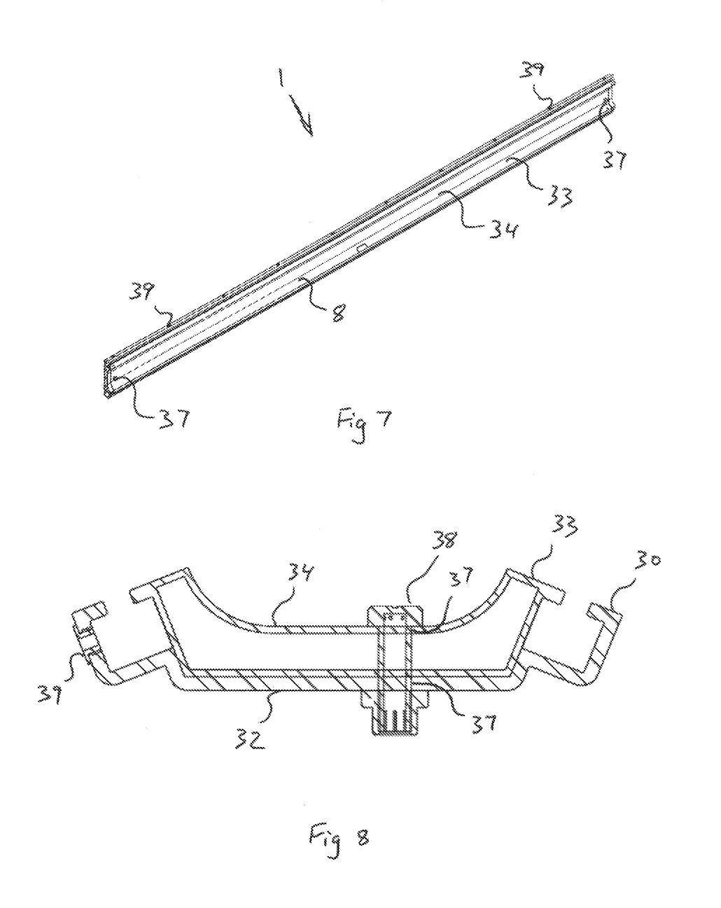

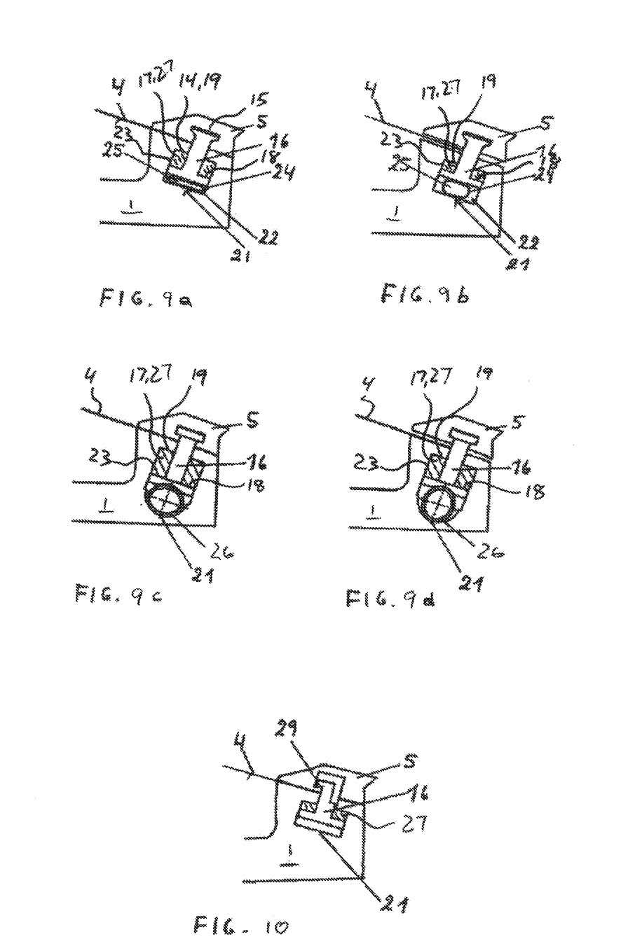

FIG. 4 shows a cross-section through a part of the doctor blade chamber 1 in a further embodiment according to prior art for fixing a doctor blade 4. The profiled rail 16 in the clamping device is designed with an edge 29 that is similar to a hook in cross-section, engaging the clamping rail 5 so that the clamping rail 5 can be lifted off the profiled rail 16 when it is pressed outwards in direction away from the bottom 21 of the doctor blade chamber groove by means of a not shown displacing mechanism. This embodiment is an advantage in that mounting and dismounting of the clamping rail 5 can be performed easily and quickly, e.g. when the interspace between the doctor blade 4 and the clamping rail 5 or between the doctor blade 4 and the doctor blade chamber 1 is to be cleaned.

FIG. 5 shows a composite doctor blade chamber 1 in cross-section, by which it appears that the doctor blade chamber is made of two composite profiles that are shown separated in the form of an open profile 30 with a front side 31 and a back side 32, and a closed profile 33 with a front side 34 and a back side 35.

FIG. 6 shows a composite doctor blade chamber 1 according to the invention in cross-section, where it appears that the two composite profiles shown on FIG. 5 are assembled now as the front side 31 of the open profile is in contact with the back side 35 of the closed profile, wherein the two composite profiles are joined by means of e.g. glue. A T-shaped groove 14 is also seen on FIG. 6 at either side of and along the open channel 8, by which it also appears that part of the T-groove 14 is constituted by the open profile 30 and part of the T-groove 14 is constituted by the closed profile 33. In the embodiment shown here, the closed profile 33 contains a foam 36 with stabilising properties.

FIG. 7 shows a composite doctor blade chamber 1 according to the invention in perspective view, by which it appears that a number of nozzle apertures 37 are provided in open channel 8 at the front side 34 of the closed profile. The Figure also shows a number of threaded inserts 39 for application of various fastenings, fittings and the like.

FIG. 8 shows a composite doctor blade chamber 1 according to the invention and as shown in FIG. 7 seen in cross-section through a nozzle 38 mounted in a nozzle aperture 37, by which it appears that the nozzle aperture 37 goes through the doctor blade chamber 1 and is fastened at the back side 32 of the open profile 30.

FIGS. 9a-d basically show the same principle with displacing mechanisms as shown on FIGS. 3a-d, but where the doctor blade chamber 1 here is a composite doctor blade chamber and where the wave spring 20 in the interspace 17 between one side 18 of the profiled rail and the inner edge 19 of the doctor blade chamber has been replaced by an elastic profile of foam polymer 27 (shown hatched).

FIG. 10 basically also shows the same principle of the design of the profiled rail on FIG. 4, but where an elastic profile of foam polymer 27 (shown hatched) is provided and where the displacing mechanisms are omitted as well.

1. A method for making a composite doctor blade chamber that includes two composite profiles, wherein the method at least comprises the following step, wherein an open profile with a front side and a back side and a closed profile with a front side and a back side are joined between front side of the open profile and the back side of the closed profile.

2. A method for making a composite doctor blade chamber according to claim 1, wherein the front side of the open profile and the back side of the closed profile are joined by glue.

3. A method for making a composite doctor blade chamber according to claim 1, wherein at least part of the composite doctor blade chamber is made by means of one of the following processes: pultruding; moulding.

4. A composite doctor blade chamber made according to the method indicated in claim 1 for a doctor blade chamber system for rotary printing units, the doctor blade chamber including a front side with an open channel, wherein the doctor blade chamber further includes two composite profiles, an open profile with a front side and a back side and a closed profile with a front side and a back side, wherein the front side of the open profile is joined with the back side of the closed profile.

5. A composite doctor blade chamber according to claim 4, wherein the composite profiles at least include carbon fibres.

6. A composite doctor blade chamber according to claim 4, wherein the joining of the profiles includes glue.

7. A composite doctor blade chamber according to claim 4, wherein the composite doctor blade chamber includes a groove, preferably a T-shaped groove, at either side of and along the open channel.

8. A composite doctor blade chamber according to claim 4, wherein the composite doctor blade chamber at least includes a cleaning nozzle in the open channel.

9. A doctor blade chamber system for rotary printing units, including a doctor blade chamber, a clamping rail and a doctor blade, wherein the doctor blade chamber is a composite doctor blade chamber, and where the doctor blade is clamped between the clamping rail and the composite doctor blade chamber, the clamping action being provided by an elongated profiled rail with a first side engaging a groove in the clamping rail, preferably a T-shaped groove, and with a second side engaging a groove in the composite doctor blade chamber, preferably a T-shaped groove, wherein a resilient element displaces the profiled rail in the groove of the doctor blade chamber inwards in direction of the bottom of the doctor blade chamber groove, the resilient element including elastic foam provided between a wall of the doctor blade chamber groove, the wall being opposite the bottom of the doctor blade chamber groove, and the profiled rail, such that the foam by expansion urges the profiled rail in direction towards the bottom of the doctor blade chamber.

10. A doctor blade chamber system according to claim 9, wherein the doctor blade chamber system also includes a rigid oval tube that is rotatable about its longitudinal axis, the tube disposed between the bottom of the groove and the profiled rail in the groove, the rigid oval tube that is rotatable about its longitudinal axis counteracting the resilient foam when activated so that the doctor blade thereby is no longer clamped between the clamping rail and the composite doctor blade chamber.

11. A doctor blade chamber system according to claim 9, wherein the doctor blade chamber system also includes an elastic tube disposed in the groove of the composite doctor blade chamber between the bottom of the groove and the profiled rail in the groove, the elastic tube capable of pneumatically expanding and counteracting the resilient foam when activated so that the doctor blade thereby is no longer clamped between the clamping rail and the composite doctor blade chamber.

12. A doctor blade chamber system according to claim 11, wherein the doctor blade chamber system includes an air supply.

13. Use of a doctor blade system according to claim 9 for use in a printing unit, e.g. a flexographic printing unit.
